(19) United States
(12) Patent Application Publication
(10) Pub. No.: US 2025/0299262 A1
(43) Pub. Date: Sep. 25, 2025

(54) TECHNIQUES FOR GENERATING PRIOR AUTHORIZATION DOCUMENTATION

(71) Applicant: Waymark, Inc., San Francisco, CA (US)

(72) Inventors: Sadiq Y Patel, Exeter, NH (US); Sanjay Basu, San Francisco, CA (US)

(73) Assignee: Waymark, Inc., San Francisco, CA (US)

(21) Appl. No.: 18/615,641

(22) Filed: Mar. 25, 2024

(51) Int. Cl. G06Q 40/08

(52) U.S. Cl. CPC G06Q 40/08

(57) ABSTRACT

In some implementations, the device may include receiving a prompt via a graphical user interface of a computing device, where the prompt identifies a target institution of a plurality of institutions, a patient condition, and a treatment. In addition, the device may include providing the prompt as input to ac generative language model, where the generative language model may include a pre-trained machine learning model that was initially trained on a general domain and subsequently trained on a target domain. The device may include receiving a generated pre-authorization letter as output from the generative language model, where the generated pre-authorization letter includes one or more fields identifying information requested from a user of the computing device. Moreover, the device may include presenting the generated pre-authorization letter to the user via the graphical user interface of the computing device.

### FIELD

This disclosure generally relates to generative language models, and more specifically relates to techniques for using a generative language model to generate prior authorization documentation.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system for implementing techniques for generating prior authorization documentation according to various embodiments;

FIG. 2 shows an example sequence diagram for generating authorization documentation according to various embodiments;

FIGS. 3-4 show example graphical user interfaces (“GUIs”) for implementing techniques for generating prior authorization documentation according to various embodiments;

FIG. 5 shows an architecture for training a machine learning model according to various embodiments;

FIG. 6 shows an example machine learning model of a neural network to various embodiments;

FIG. 7 shows an example method for implementing techniques for generating prior authorization documentation according to various embodiments; and

FIG. 8 shows an example computing device suitable for use with example techniques for generating prior authorization documentation according to various embodiments.

### DETAILED DESCRIPTION

Examples are described herein in the context of isolating videoconference streams. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Prior-authorization documentation (e.g., prior-authorization letters) are forms or letters that are submitted to insurance companies, third-party payers, or government institutions (e.g., target institutions) to determine if a patient's treatment will be approved. These letters describe the patient's condition, desired treatment, and information justifying this treatment. Prior-authorization is intended as a cost saving and safety check to ensure that a patient is receiving proper care. For example, prior-authorization may be required to verify that a new medication does not interfere with the patient's existing medications.

However, the prior-authorization process can be unforgiving, and delays associated with prior-authorization may result in substandard care. Prior-authorization documentation may be denied for any number of reasons and the specific requirements for a particular prior-authorization can vary by treatment and target organization. For example, some treatments are part of “step therapy” where treatments must be performed in a specific order in order for the target institution to approve them. A patient with a severe condition may be denied care because the prior-authorization letter did not provide adequate treatment history for the target institution do determine that the specific order of treatment has been followed. A rejected prior-authorization letter can cause weeks of delayed treatment and emergency room visits can spike during these delays.

Medical practitioners may not understand all of the nuances required by each target institution. The requirements for prior-authorization letters can vary significantly between target institutions and an acceptable letter for one institution may be rejected by a different institution. In addition, completing prior-authorization letters can be time consuming and frustrating for medical professionals. Accordingly, preparing prior-authorization letters can be a high-stakes, frustrating, and time-consuming process for medical professionals.

To address these and other issues, generative language models can be trained to prepare prior-authorization documentation. Generative language models can be machine learning models that are capable of understanding and reproducing language. These models can be pre-trained to perform general-purpose tasks in a particular language. In addition, such models can then be trained to replicate prior-authorization documentation by post-training the models on prior-authorization documentation that satisfies the requirements for a particular target institution. After post-training, a medical professional can use the language model to quickly produce acceptable prior-authorization documentation.

For example, a medical professional (e.g., a user) can request a prior-authorization letter using a graphical user interface. The user can provide a prompt that identifies the patient, the target institution, and the requested treatment. The machine learning model (e.g., generative language model) can use this information to create a prior-authorization letter for the requested treatment that satisfies the target institution's requirements. The user can edit the letter, and, after editing, the user can submit the prior-authorization documentation to the target institution.

The techniques described herein offer several technical advantages. For example, the disclosed system can retrieve relevant information and generate a prior-authorization document within a single page of a graphical user interface. Without such a system, a user may have to query multiple databases, with different graphical user interfaces, to retrieve this information and prepare prior-authorization documentation. The retrieved information can be in different formats, and the system can automatically transform this information into a standardized format (e.g., a letter). This transformation can include anonymizing the received information by replacing personally identifiable information with anonymized placeholders to protect patient data. The transformation can also include replacing the anonymized placeholders with the removed personal identifiable information in the generated letter. Such transformations can reduce the risk that personal information is exposed as well as the number of individuals that view the personal information (e.g., because a letter can be generated without directly accessing the information). In addition, the techniques can reduce unnecessary network traffic by verifying that a prior authorization documentation satisfies a target institution's acceptance criteria before transmitting the documentation to the institution. The user interface can reduce the amount of user input that is needed to create a pre-authorization document. For example, the user input can be a short prompt rather than the full text of a letter.

This illustrative example is given to introduce the reader to the general subject matter discussed herein and the disclosure is not limited to this example. The following sections describe various additional non-limiting examples and examples of controlling virtual conference settings.

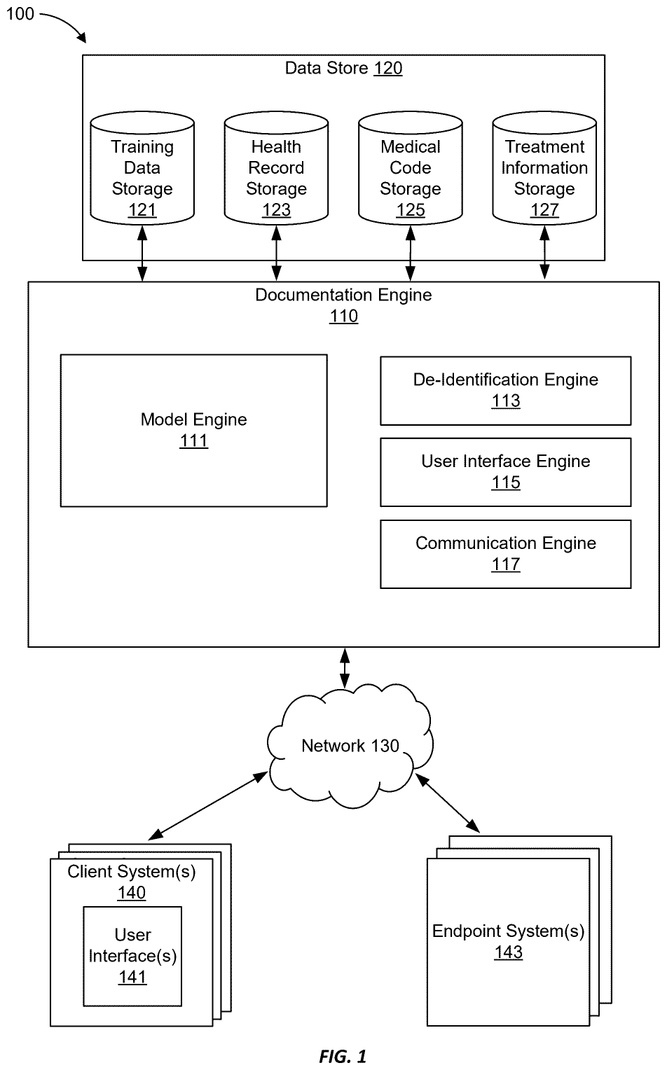

Referring now to FIG. 1, FIG. 1 illustrates an example system 100 for implementing techniques for generating prior authorization documentation according to various embodiments. Prior authorization documentation can be text-based documentation that is used by an institution to determine whether to pay for a particular treatment. The institution can be an insurance provider, government agency, or any other entity that authorizes or provides payment for medical treatments.

System 100 can include a documentation engine 110 that can be used to generate pre-authorization documentation. The documentation engine 110 can include a model engine 111 that includes one or more machine learning models that can generate this documentation. For example, the documentation engine can include generative language models such as neural networks or any applicable type of large language model. Machine learning models can be deployed by model engine 111. Deploying the model can mean providing input to the model and receiving output from the model. Model engine 111, and the other engines depicted in system 100, can include any combination of software and hardware for implementing the techniques described herein.

Model engine 111 can facilitate training of the machine learning models associated with the engine. For example, one or more of the machine learning models can be pre-trained models that were trained on general domains. A domain for a generative language model can be a corpus of text that is used to train the model. During model training, the model parameters are iteratively updated until the model's output satisfies some criteria (e.g., an accuracy score; an expected output is provided for a given input). Generative language models can simulate written or spoken conversations. So, the model can be trained until a given input (e.g., a prompt) receives a responsive (e.g., an on topic and intelligible) answer.

A pre-trained model that was trained on general domains may need to be trained on a target domain to perform certain tasks. General domains can include a broad cross section of text from a language and models trained on these domains can be trained to understand the language. For example, machine learning models trained on these domains can perform natural language tasks such as segmentation, tokenization, sentiment analysis, syntactic analysis, named entity recognition, etc. However, such pre-trained models may not be able to perform specific tasks without additional training. For example, pre-trained models trained on general domains may struggle to accurately respond to specialized terminology such as jargon from a particular discipline (e.g., medical terminology). In addition, a pre-trained large language model may provide a conversational answer and may not provide a response in a particular format. Accordingly, such general domain models may need to be post-trained (e.g., trained again) on a target domain.

Model engine 111 can post-train a pre-trained model by training the model on a target domain. The target domain can include text documents that the pre-trained model is intended to understand or replicate. For example, the target domain can be medical textbooks, and a pre-trained model that is post-trained on this target domain should be able to understand medical terminology in prompts after post training. Similarly, the target domain can be pre-authorization letters (e.g., pre-authorization documentation) for a particular target institution (e.g., medical insurance provider). This training data can be stored in the training data storage 121 in data store 120. After post training, the model should be able to generate a pre-authorization letter that is similar to the target domain pre-authorization letters.

Documentation engine 110 may transform, reformat, edit, or otherwise alter a prompt before the prompt is provided to the model. For example, the prompts may include personally identifiable information (e.g., information that can be linked to a particular person, protected health information, etc.) that may not be appropriate to provide directly to the model in model engine 111. Some machine learning models can be provided by organizations that use the prompts provided to the model as training data. Customers may not want certain information exposed publicly, and exposure of personal medical information is controlled by the Health Insurance Portability and Accountability Act (HIPPA). Accordingly, de-identification engine 113 can anonymize the information provided to the model engine 111 so that no personal information is exposed outside of system 100.

De-authentication engine 113 can identify personally identifiable information in a prompt and remove this information from the prompt. In addition or alternatively, the de-identification engine can assign a unique identifier for the removed information before the prompt is provided to the model engine 111. The de-identification engine 113 can maintain a mapping between the removed information and unique identifiers. After a response is returned by the model engine 111, the de-identification engine 113 can locate the unique identifiers and return the personally identifiable information to the response. The information may be returned because pre-authorization documentation may need some personally identifiable information in order for the target institution to evaluate the requested treatment. The personally identifiable information can be stored in the health record storage 123 in data store 120 and can include: names, geographic locators, dates, telephone numbers, fax numbers, email addresses, internet protocol (IP) addresses, social security numbers, medical record numbers, health plan beneficiary numbers (e.g., a unique identifier number on a patient's health insurance card), device identifiers, certificate/license numbers (e.g., driver license numbers and birth certificate numbers), account numbers (e.g., bank account numbers), vehicle identifiers (e.g., license plates and vehicle identification numbers VIN), universal resource locators (URLs), biometric identifiers, or any other unique identifying information.

Documentation engine 110 can include a user interface engine 115. The user interface engine 115 can provide and manage user interface(s) 141 operating on client system(s) 140. A client system 140 can request functionality from documentation engine 110, and, after authentication of the client system, a user interface 141 can be provided by the user interface engine 115. The user interface 141 can be a browser extension or an application, and communication between the user interface and user interface engine 115 can occur over network 130.

Communication engine 117 can facilitate communication within system 100. For example, communication engine 117 can retrieve or store information in data store 120. A model associated with model engine 111 may require information from data store 120 in order to generate a response. For example, a prompt may include a plain language term for a treatment (e.g., fractured tibia) and a target institution may need a specific code or terminology to authorize that treatment. The codes in the medical code storage 125 can be mapped to these plain language terms and the communication engine 117 can provide the term in a request, received from model engine 111, to the storage and receive the corresponding code or terminology in response. Similarly, treatment information storage 127 can include mappings between plain language treatments and codes/terminology corresponding to the plain language treatments. The communication engine 117 can include the plain language treatment, received from model engine 111, in a request to treatment information storage 127.

Communication engine 117 can facilitate communication over network 130. Prompts and responses can be communicated between documentation engine 110 and client system(s) 140 and communication engine 117 can facilitate this communication. The communication engine 117 may authenticate client system(s) 140 as part of this communication. In addition, completed pre-authorization documentation (e.g., a response) can be provided to endpoint system(s) 143 associated with the documentation's target institution. For example, the endpoint system(s) 143 can be a digital fax endpoint (e.g., a computing device that can transmit and receive faxes) or an intake endpoint on the target institution's system (e.g., a server computer).

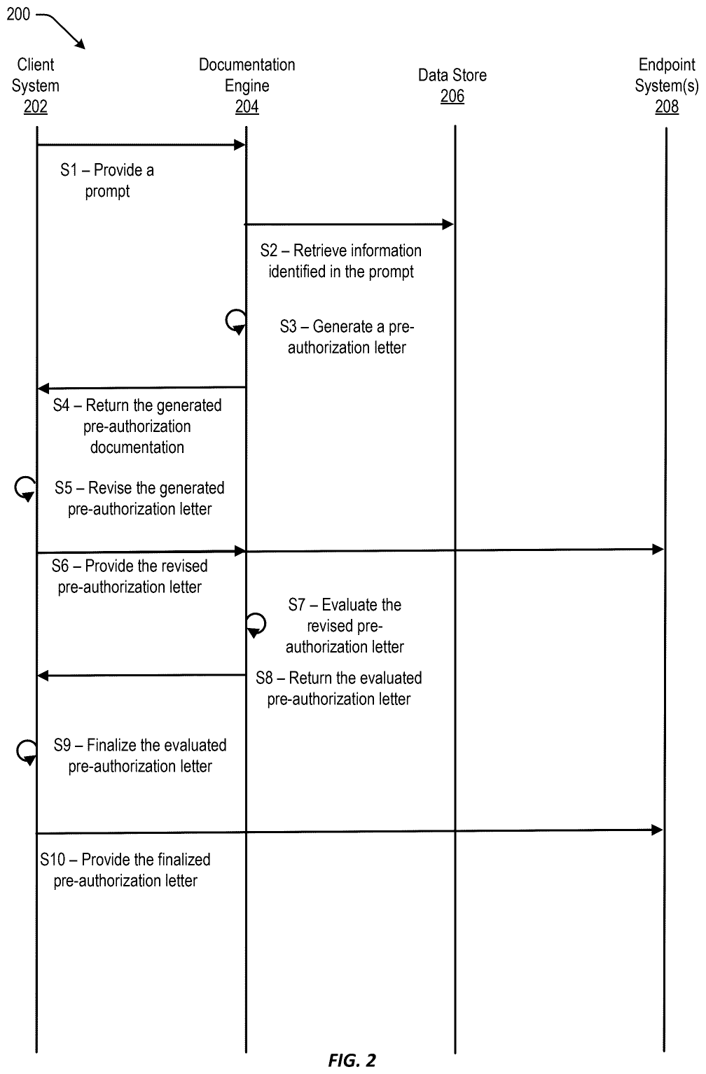

Referring now to FIG. 2, FIG. 2 shows an example sequence diagram 200 for generating authorization documentation according to various embodiments. The descriptions for components described with reference to system 100 can apply to similar components described with reference to diagram 200.

Turning now to diagram 200 in greater detail, at S1, client system 202 can provide a prompt to documentation engine 204. The prompt can be provided as a text-based query that was provided via a user interface executing on client system 202. A text-based query can be in conventional conversational language (e.g., “please write a prior authorization letter to Company A for a patient with strep throat”) or the text-based query can be a stylized query that uses truncated language (e.g., “Company A letter strep”). The query can include proper words, abbreviations, acronyms, jargon, etc. Client system can be a computing device such as a personal computer, a server computer, a tablet computer, a smartphone, etc. Client subsystem 202 may be authenticated by documentation engine 204 as part of providing the prompt.

At S2, information identified in the prompt can be retrieved from the data store 206 by the documentation engine 204. The information can include health record information from health record storage, medical codes from medical record storage, and/or treatment information from treatment information storage. For example, the prompt received at S1 can identify a patient by a proper name, and the communication engine in documentation engine 204 can retrieve a medical identifier associated with the proper name. Retrieving information can include removing personal identifiable information from the prompt using a de-identification engine associated with documentation engine 204. For example, the personal identifiable information may be identified and removed from the prompt. The removed information can be replaced with anonymized placeholders so that personal identifiable information is not exposed to the one or more machine learning models.

At S3, a pre-authorization letter can be generated by documentation engine 204. Generating the pre-authorization letter can include providing the prompt from S1 and the information retrieved at S2 as input to one or more machine learning models, such as a large language model. The machine learning model may be a pre-trained machine learning model or a post-trained machine learning model.

At S4, the pre-authorization letter generated at S3 can be returned by documentation engine 204 to the client system 202. The pre-authorization letter can be returned by a communication engine in documentation engine 204 and via a network. In some embodiments, the client system at S4 can be a different client system from the client system at S1.

At S5, the pre-authorization letter generated at S3 can be revised. In some embodiments, revising this generated pre-authorization letter can mean that the letter is approved without changes to the letter. In some embodiments, revising this generated pre-authorization letter can include changes to the text of the letter. These changes can be provided by a user via a graphical user interface executing on client system 202. In some embodiments, the changes can be provided as one or more additional prompts such as those provided at S1. The one or more additional prompts can identify requested changes to the draft letter. In some embodiments, the draft letter can be provided with the prompt as input to the machine learning model. If an additional prompt is provided, the technique can return to S3.

At S6, the revised pre-authorization letter from S5 can be provided. In some embodiments, the pre-authorization letter can be provided to one or more endpoint system(s) 208 (e.g., the letter is submitted to a target institution). The one or more endpoints can be the destination for the letter. In some embodiments, the pre-authorization letter can be provided to the documentation engine 204. The pre-authorization letter may be provided so that the revised letter can be evaluated using a machine learning model in documentation engine 204. A user controlling client system 202 may decide whether to send the revised pre-authorization letter to documentation engine 204 or endpoint system(s) 208 by providing input to a graphical user interface executing on client system 202.

At S7, the documentation engine 204 can evaluate the revised pre-authorization letter from S5 by providing the letter as input to one or more machine learning models. The one or more machine learning models can provide an output in response to the input letter. For example, the machine learning model may assign a score to the pre-authorization letter and the score can be output from the machine learning model. The score can be a probability that the letter would be approved by the target institution. In some embodiments, the score can be compared to one or more thresholds to determine a classification for the letter. For example, the letter may be classified as likely to be approved by the target institution if the score is above a threshold, and the letter may be classified as unlikely to be approved if the score is below the threshold. In some embodiments, the letter may be automatically sent to a target institution if the classification is above a second threshold (e.g., above 70% the letter is classified as likely to be approved and above 95% the letter is automatically sent to the target institution). A notification to the user may generated if the classification is not above a threshold, and the letter may indicate that the letter is not likely to be approved. In some embodiments, the notification can provide one or more suggested changes for the letter based on the classification. In some embodiments, the letter may be resubmitted to the machine learning model if the letter is below a threshold. The machine learning model can revise the input letter (e.g., rewrite one or more sentences), suggest specific changes to the letter (e.g., “reword the highlighted sentence”), or provide general feedback (e.g., “the letter is too long”). In some embodiments, the letter or a notification may be provided to another client system if the classification for the letter is below a threshold (e.g., a notification may be provided to a device in the pharmacy department if the letter is below the threshold).

At S8, the evaluated pre-authorization letter from S7 can be returned from the documentation engine 204 to the client system 202. The evaluated pre-authorization letter can be returned via a network and using a communication engine of the documentation engine 204. In some embodiments, the evaluated pre-authorization letter can be sent to one or more endpoint system(s) 208 after evaluation. For example, the machine learning model may assign a score to the evaluated pre-authorization letter at S7, and the letter may be sent directly to one or more endpoint system(s) 208 (e.g., without additional user input) if the score is above a threshold. The endpoint system(s) 208 can correspond to one or more target institutions.

At S9, the evaluated pre-authorization letter from S7 can be finalized. Finalizing the letter can mean that a user of client system 202 provides information indicating approval of the pre-authorization letter via a graphical user interface executing on client system 202. For example, the user may select a button indicating approval or digitally sign the evaluated pre-authorization letter to indicate approval. The user may alter the text of the letter using a graphical user interface executing on client system 202 to finalize the evaluated pre-authorization letter. In some embodiments, finalizing the model may include replacing any anonymized placeholders from S2 with the corresponding personal identifiable information.

At S10, the finalized pre-authorization letter from S9 can be provided from client system 202 to endpoint system(s) 208. The finalized pre-authorization letter can be returned via a network and using a communication engine of the documentation engine 204.

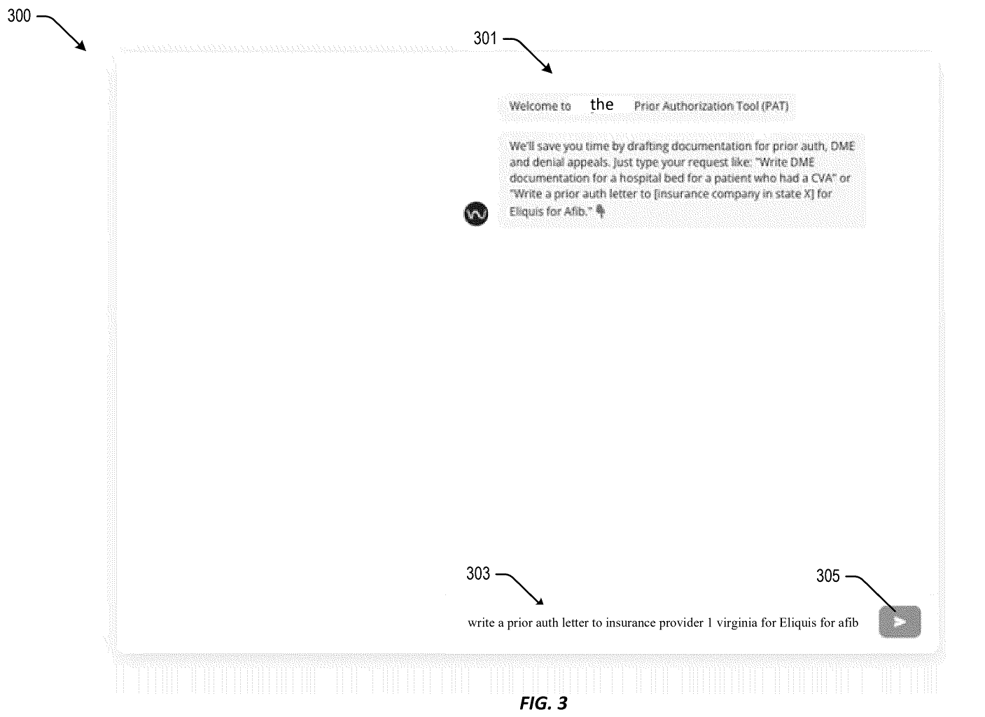

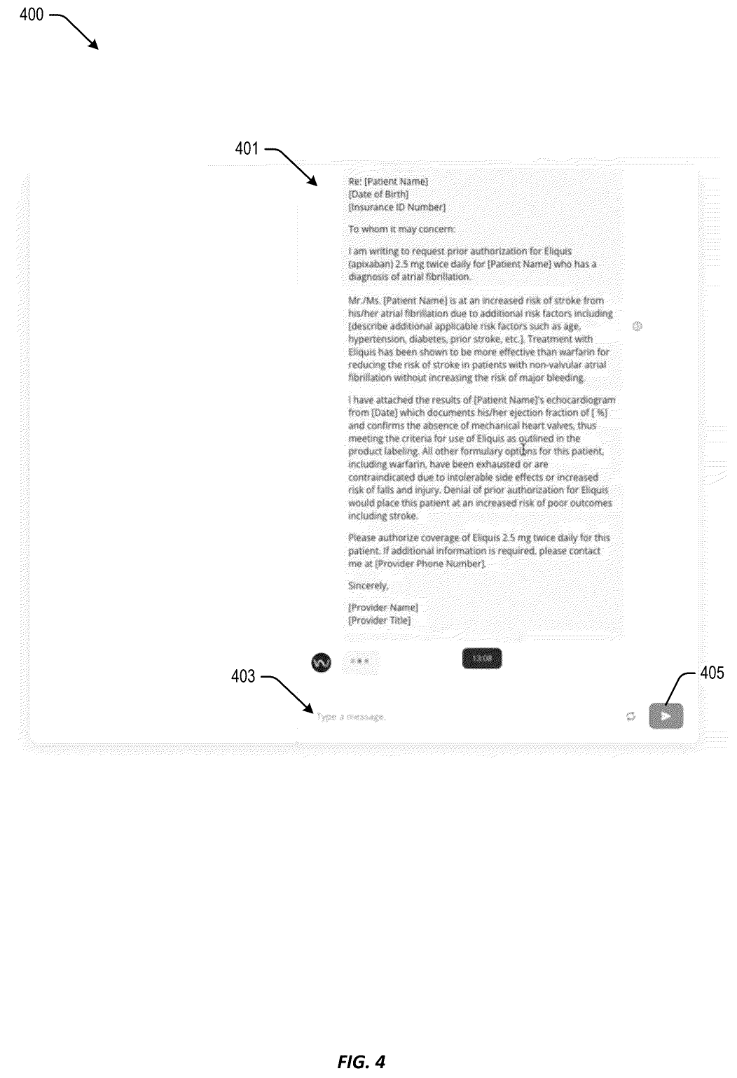

FIG. 3 shows an example graphical user interface 300 (“GUI”) for implementing techniques for generating prior authorization documentation according to various embodiments. GUI 300 includes a field 301 which presents output from one or more machine learning models. As shown in GUI 300, field 301 shows instructions for generating a prompt as well as suggested prompts. A user can provide a prompt by providing text to field 303. In some embodiments, the prompt can be provided as speech that is transcribed into a text-based prompt. After the user has written a prompt in field 303, the user can select interactive element 305 to provide the prompt as input to the machine learning model. In this case the prompt is “write a prior auth letter to insurance provider 1 virginia for Eliquis for afib.” After selecting interactive field 305, the graphical user interface can be updated as shown in FIG. 4.

FIG. 4 shows an example graphical user interface 400 (“GUIs”) for implementing techniques for generating prior authorization documentation according to various embodiments. GUI 400 includes field 401 which displays a response to the prompt provided in field 303. The response is an output from one or more machine learning models and the response is shown as text corresponding to a pre-authorization letter. In some embodiments, the bracketed text (e.g., “[Provider Title]) may be provided as interactive fields that a user can use to type responses (e.g., into a text field) or select responses (e.g., from a drop-down menu). The user can fill out the response by completing the information in the bracketed fields. In some embodiments, this information can be automatically completed by a documentation engine that retrieves the information corresponding to the bracketed fields and inserts the information into the corresponding locations. The user can provide the completed letter to field 403 and select interactive element 405 to prompt the one or more machine learning models to evaluate the completed letter. Instructions to system 100 can be provided as plain language instructions via field 403. For example, the system can be instructed to send the pre-authorization letter to an endpoint system by typing “submit the letter” in field 403. In some implementations, interactive elements can be used to control system 100 (e.g., a submit button).

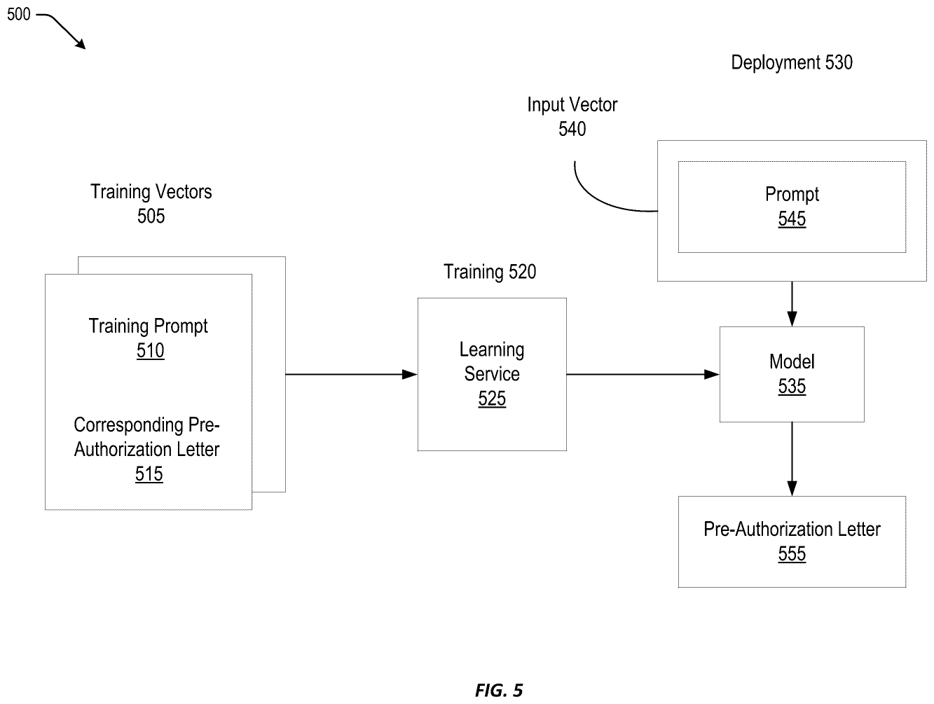

FIG. 5 depicts an architecture for training a machine learning model according to the embodiments of the present disclosure. Training vectors 505 are shown with training prompts 510 and a corresponding pre-authorization letter 515. Training prompts 510 can include sample prompts that were created for pre-authorization letters that satisfy the criteria for a particular target institution (e.g., corresponding pre-authorization letters). For ease of illustration, only two training vectors are shown, but the number of training vectors may be much larger, e.g., 10, 50, 100, 1,000, 10,000, 100,000, millions, or more. Training vectors could be made for different services, the same service over different time periods.

A corresponding pre-authorization letter 515 can have multiple training prompts 510. There are many ways that a user could describe desired pre-authorization letter, and multiple training prompts 510 can be created for any particular corresponding pre-authorization letter 515. For example, a corresponding pre-authorization letter 515 can be associated with a prompt using technical jargon, a prompt using abbreviations, a prompt using casual language, a prompt with errors, a prompt with missing information, etc.

Training vectors 505 can be used by a learning service 525 to perform training 520. A service, such as learning service 525, being one or more computing devices configured to execute computer code to perform one or more operations that make up the service. Learning service 525 can optimize parameters of a model 535 such that a quality metric (e.g., accuracy of model 535) is achieved with one or more specified criteria. The accuracy may be measured by comparing corresponding pre-authorization letters 515 to predicted pre-authorization letters. Parameters of model 535 can be iteratively varied to increase accuracy. Determining a quality metric can be implemented for any arbitrary function including the set of all risk, loss, utility, and decision functions.

In some embodiments of training, a gradient may be determined for how varying the parameters affects a cost function, which can provide a measure of how accurate the current state of the machine learning model is. The gradient can be used in conjunction with a learning step (e.g., a measure of how much the parameters of the model should be updated for a given time step of the optimization process). The parameters (which can include weights, matrix transformations, and probability distributions) can thus be optimized to provide an optimal value of the cost function, which can be measured as being above or below a threshold (i.e., exceeds a threshold) or that the cost function does not change significantly for several time steps, as examples. In other embodiments, training can be implemented with methods that do not require a hessian or gradient calculation, such as dynamic programming or evolutionary algorithms.

A deployment stage 530 can provide a pre-authorization letter 555 for a prompt's input vector that is based on prompt 545. The pre-authorization letter 555 can be a generated pre-authorization letter corresponding to the input vector 540. The prompt 545 values can be of a similar type as training prompt 510. Ideally, pre-authorization letter 555 corresponds to the desired pre-authorization letter for input vector 540.

A “machine learning model” (ML model) can refer to a software module configured to be run on one or more processors to provide a classification or numerical value of a property of one or more samples. An ML model can be generated using sample data (e.g., training data) to make predictions on test data. One example is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

Examples of machine learning models include large language models, deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

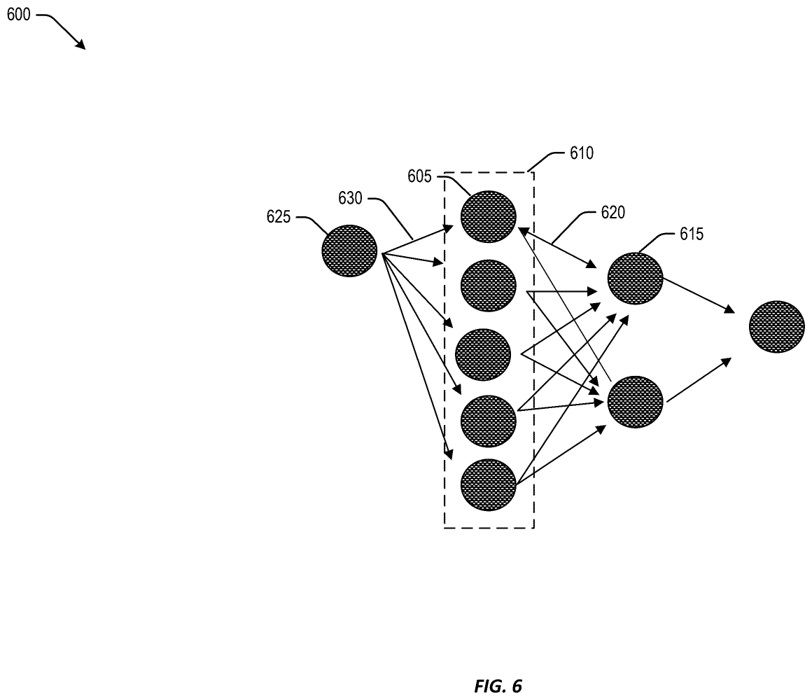

FIG. 6 shows an example machine learning model of a neural network. As an example, model 635 can be a neural network that comprises a number of neurons (e.g., Adaptive basis functions) organized in layers. For example, neuron 605 can be part of layer 610. The neurons can be connected by edges between neurons. For example, neuron 605 can be connected to neuron 615 by edge 620. A neuron can be connected to any number of different neurons in any number of layers. For instance, neuron 605 can be connected to neuron 625 by edge 630 in addition to being connected to neuron 615.

The training of the neural network can iteratively search for the best configuration of the parameter of the neural network for feature recognition and classification performance. Various numbers of layers and nodes may be used. A person with skills in the art can easily recognize variations in a neural network design and design of other machine learning models. For example, neural networks can include graph neural networks that are configured to operate on unstructured data. A graph neural network can receive a graph (e.g., nodes connected by edges) as an input to the model and the graph neural network can learn the features of this input through pairwise message passing. In pairwise message passing, nodes exchange information and each node iteratively updates its representation based on the passed information.

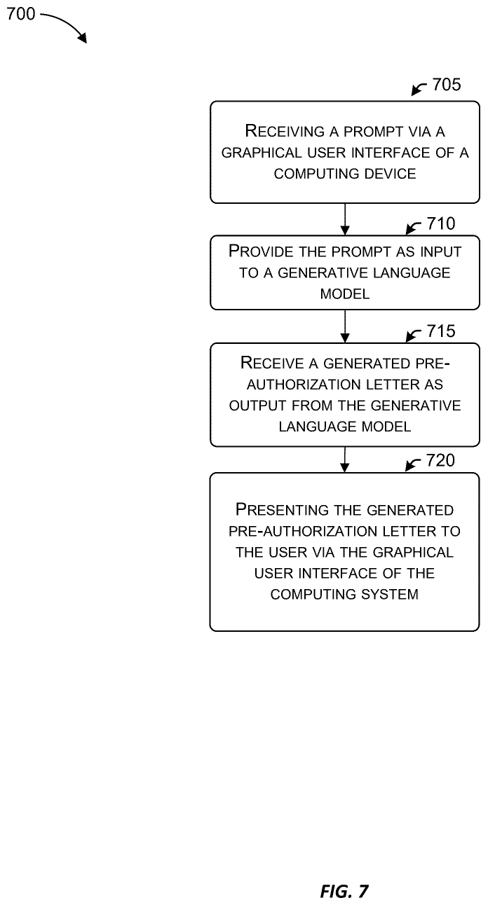

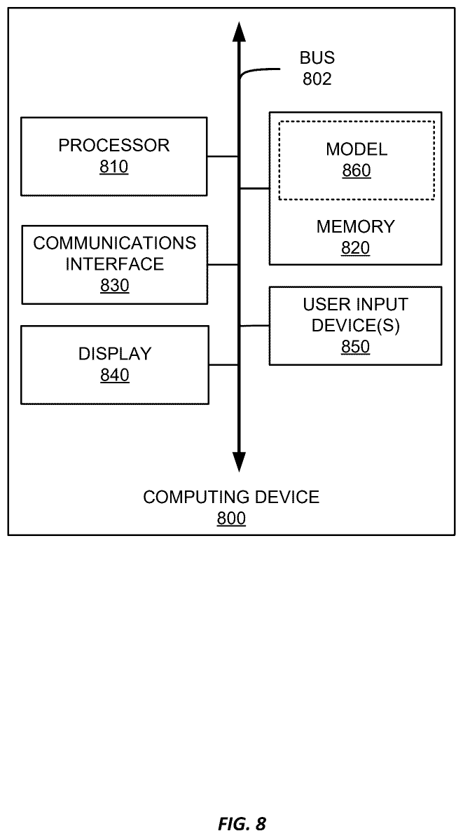

Referring now to FIG. 7, FIG. 7 shows an example method 700 for implementing techniques for isolating videoconference streams according to various embodiments. This example method 700 will be described with respect to the system 100 shown in FIG. 1, the sequence diagram 200 shown in FIG. 2, the example GUIs 300-400 shown in FIGS. 3-4; and the example computer device 800 shown in FIG. 8; however, any suitable systems or GUIs according to this disclosure may be employed.

At block 705, a prompt can be received via a graphical user interface of a computing device. The prompt can identify a target institution of a plurality of target institutions, a patient condition, and a treatment. A prompt can be text, speech, and/or any information that describes a requested pre-authorization letter. For example, the prompt can be conversational plain language text that describes a requested authorization letter (e.g., “Can you provide me with a pre-authorization letter for patient Smith's drug prescription?”). The prompt may be an ordered list of text for a desired pre-authorization letter (e.g., “pre-auth, patient Smith, drug prescription.”). Further, some prompts may be input in shorthand, such as by using jargon, e.g., “write a prior auth letter to insurance provider virginia for Eliquis for afib,” which includes shorthand (e.g., “auth”) and jargon (e.g., “afib”).

The target institution can be one or more insurance providers or government agencies that approve or deny requests for treatment. A treatment can be durable medical equipment, medical procedures, and/or pharmaceutical compounds that are used to provide care for a patient condition. A patient condition can be a medical diagnosis, a symptom, and/or a state of a patient that can be altered by a treatment.

At block 710, the prompt can be provided as input to a generative language model. In some embodiments, the generative language model can be one or more machine learning models. The machine learning models can be one or more pre-trained machine learning models that were initially trained on a general domain. A general domain can be a volume of text corresponding to a large number of topics in a particular language (e.g., information gathered from the internet using common crawl). A target domain can be a volume of text in a particular language corresponding to a particular discipline, industry, or topic. The target domain can include template prior-authorization letters (e.g., prior-authorization letters that have been accepted by a target institution or prior-authorization letters that satisfy the acceptance criteria of the target institution). The template prior-authorization letters can be labeled with a corresponding target institution, a corresponding patient condition, and/or a corresponding treatment.

At step 715, a generated pre-authorization letter can be provided as output from the generative language model. The generated pre-authorization letter can include one or more fields identifying information requested from a user of the computing device. In some implementations, the pre-authorization letter may not include any requested information.

At step 720, the generated pre-authorization letter can be presented to the user via a graphical user interface of the computing device. In some implementations, the computing device at step 705 can be different from the computing device at step 720 (e.g., the letter is sent to a separate device for presentation). The requested information from step 715 can be presented on the graphical user interface. The fields can be text fields (e.g., text boxes) or interactive elements in a graphical user interface (e.g., buttons, drop-down menus, etc.). The pre-authorization letter may be presented as a text document without any fields in the graphical user interface and the fields from step 715 can be replaced by bracketed text (e.g., text that is visually set apart from the remainder of the text).

Input to the one or more fields of the generated pre-authorization letter can be received via the graphical user interface. After input is received, the generated pre-authorization letter can be provided as input to one or more machine learning models and one or more updates to the one or more fields of the letter can be provided as output from the generative language model (e.g., a large language model can revise the letter).

In some embodiments, the user can finalize the letter by providing information indicating approval of the pre-authorization letter via a graphical user interface. For example, the user may select a button indicating approval or digitally sign the evaluated pre-authorization letter to indicate approval. Finalizing the letter may include altering the text of the letter using a graphical user interface. In some embodiments, finalizing the model may include replacing any anonymized placeholders with the corresponding personal identifiable information. The finalized letter may be sent to a target institution via a network connection. The letter may be sent in any applicable format such as an image file, a text file, a word processing file, etc. Sending the letter may include generating the applicable format or transforming the letter's current format to the applicable format for a target institution.

Referring now to FIG. 8, FIG. 8 shows an example computing device 800 suitable for use in example systems or methods for systems for techniques for generating prior authorization documentation according to various embodiments. The example computing device 800 includes a processor 810 which is in communication with the memory 820 and other components of the computing device 800 using one or more communications buses 802. The processor 810 is configured to execute processor-executable instructions stored in the memory 820 to perform one or more techniques for generating prior authorization documentation according to different examples, such as part or all of the example method 800 described above with respect to FIG. 8. The computing device 800, in this example, also includes one or more user input devices 850, such as a keyboard, mouse, touchscreen, microphone, etc., to accept user input. The computing device 800 also includes a display 840 to provide visual output to a user.

In addition, the computing device 800 includes a documentation application 860 to enable a user to provide input to a machine learning model, receive output from a machine learning model, train a machine learning model, provide and retrieve information from one or more data stores, generate a user interface, display a user interface, etc., such as described throughout this disclosure, etc.

The computing device 800 also includes a communications interface 830. In some examples, the communications interface 830 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A computer-implemented method, comprising:
receiving a prompt via a graphical user interface of a computing device, wherein the prompt identifies a target institution of a plurality of institutions, a patient condition, and a treatment;
providing the prompt as input to a generative language model, wherein the generative language model comprises a pre-trained machine learning model that was initially trained on a general domain and subsequently trained on a target domain;
receiving a generated pre-authorization letter as output from the generative language model, wherein the generated pre-authorization letter includes one or more fields identifying information requested from a user of the computing device; and
presenting the generated pre-authorization letter to the user via the graphical user interface of the computing device.

2. The computer-implemented method of claim 1, further comprising:
receiving, via the graphical user interface, an input to the one or more fields of the generated pre-authorization letter.

3. The computer-implemented method of claim 2, further comprising:
providing the generated pre-authorization letter as input to the generative language model; and
receive one or more updates to the one or more fields as output from the generative language model.

4. The computer-implemented method of claim 1, wherein the target domain comprises template prior-authorization letters.

5. The computer-implemented method of claim 4, wherein each template prior-authorization letter in the target domain is labeled with a corresponding target institution of the plurality of institutions, a corresponding patient condition, and a corresponding treatment.

6. The computer-implemented method of claim 1, wherein the generated pre-authorization letter is a text document.

7. The computer-implemented method of claim 1, wherein the one or more fields are one or more input fields of the graphical user interface.

8. A computing device, comprising:
one or more memories; and
one or more processors in communication with the one or more memories and configured to execute instructions stored in the one or more memories to performing operations comprising:
receiving a prompt via a graphical user interface of a computing device, wherein the prompt identifies a target institution of a plurality of institutions, a patient condition, and a treatment;
providing the prompt as input to a generative language model, wherein the generative language model comprises a pre-trained machine learning model that was initially trained on a general domain and subsequently trained on a target domain;
receiving a generated pre-authorization letter as output from the generative language model, wherein the generated pre-authorization letter includes one or more fields identifying information requested from a user of the computing device; and
presenting the generated pre-authorization letter to the user via the graphical user interface of the computing device.

9. The computing device of claim 8, further comprising:
receiving, via the graphical user interface, an input to the one or more fields of the generated pre-authorization letter.

10. The computing device of claim 9, further comprising:
providing the generated pre-authorization letter as input to the generative language model; and
receive one or more updates to the one or more fields as output from the generative language model.

11. The computing device of claim 8, wherein the target domain comprises template prior-authorization letters.

12. The computing device of claim 11, wherein each template prior-authorization letter in the target domain is labeled with a corresponding target institution of the plurality of institutions, a corresponding patient condition, and a corresponding treatment.

13. The computing device of claim 8, wherein the generated pre-authorization letter is a text document.

14. The computing device of claim 8, wherein the one or more fields are one or more input fields of the graphical user interface.

15. A non-transitory computer-readable medium storing a plurality of instructions that, when executed by one or more processors of a computing device, cause the one or more processors to perform operations comprising:
receiving a prompt via a graphical user interface of a computing device, wherein the prompt identifies a target institution of a plurality of institutions, a patient condition, and a treatment;
providing the prompt as input to a generative language model, wherein the generative language model comprises a pre-trained machine learning model that was initially trained on a general domain and subsequently trained on a target domain;
receiving a generated pre-authorization letter as output from the generative language model, wherein the generated pre-authorization letter includes one or more fields identifying information requested from a user of the computing device; and
presenting the generated pre-authorization letter to the user via the graphical user interface of the computing device.

16. The non-transitory computer-readable medium of claim 15, further comprising:
receiving, via the graphical user interface, an input to the one or more fields of the generated pre-authorization letter.

17. The non-transitory computer-readable medium of claim 16, further comprising:
providing the generated pre-authorization letter as input to the generative language model; and
receive one or more updates to the one or more fields as output from the generative language model.

18. The non-transitory computer-readable medium of claim 15, wherein the target domain comprises template prior-authorization letters.

19. The non-transitory computer-readable medium of claim 18, wherein each template prior-authorization letter in the target domain is labeled with a corresponding target institution of the plurality of institutions, a corresponding patient condition, and a corresponding treatment.

20. The non-transitory computer-readable medium of claim 15, wherein the generated pre-authorization letter is a text document.
